(19) United States
(12) Patent Application Publication
(10) Pub. No.: US 2025/0377159 A1
(43) Pub. Date: Dec. 11, 2025

(54) PROCESS FOR PURIFYING CO2

(71) Applicant: L'Air Liquide, Societe Anonyme pour l'Etude et l’Exploitation des Procedes Georges Claude, Paris (FR)

(72) Inventor: Mathieu LECLERC, Paris (FR)

(21) Appl. No.: 19/230,469

(22) Filed: Jun. 6, 2025

(30) Foreign Application Priority Data
Jun. 11, 2024 (FR) FRFR2406177

(51) Int. Cl. F25J 3/02

(52) U.S. Cl. CPC F25J 3/0266; F25J 2205/10; F25J 2205/90; F25J 2210/02; F25J 2215/80; F25J 2220/02

(57) ABSTRACT

Two streams containing CO₂ with different purities are separated in a common distillation column, without having been compressed or purified of water together.

### CROSS REFERENCE TO RELATED APPLICATIONS

This application claims the benefit of priority under 35 U.S.C. § 119 and (b) to French patent application No. FR2406177, filed Jun. 11, 2024, which is herein incorporated by reference in its entirety.

### FIELD OF THE INVENTION

The present invention relates to a process for purifying CO2.

### BACKGROUND OF THE INVENTION

CO2 originating from cryogenic capture processes can be combined with that from non-cryogenic capture units such as those employing amine scrubbing for example in order to be sent jointly to an export pipeline and/or to a CO2 liquefier.

It is then possible to compress the CO2 originating from the cryogenic unit at least partially in conjunction with the CO2 compression step of the non-cryogenic unit. Only drying of the CO2 from the non-cryogenic unit is required, if it contains any, the water content in this CO2 generally being too high in relation to the export and/or liquefaction constraints.

The purity of the CO2 originating from the cryogenic unit is usually much higher than that originating from other technologies. The specifications in terms of quality (impurity content) of CO2 for sequestration change regularly and are tending to become more and more stringent.

It is known to use a regeneration gas originating from a cryogenic unit in a unit for separating CO2 originating from amine scrubbing.

WO 2022/152629 proposes compression and drying of the CO2 originating from amine scrubbing using a fluid from the cryogenic unit as regeneration gas of the dryer.

FR2975478A describes the separation of two streams of CO2 having different purities but treats them in independent columns.

U.S. Pat. No. 9,784,498 provides for different separation methods depending on the purity of the CO2stream to be treated.

### SUMMARY OF THE INVENTION

In certain embodiments, the invention proposes an improvement to the process of WO 2022/152629 because, in that process, the CO2 originating from the amine scrubbing is only dried but not purified of light molecules. Diluting with the CO2 from the cryogenic unit only permits the obtaining of an average purity that is not necessarily compatible with the specification for CO2 produced.

The invention may in some cases may include:
optionally separately compressing the CO2 originating from a non-cryogenic capture unit
optionally separately drying this CO2
cooling it down to temperatures enabling distillation
injecting this dried and cooled CO2 into the column for distilling the lights from a cryogenic CO2 capture unit.

The invention may comprise the following variants/steps:
The heat exchanger for the cryogenic separation may be common with the exchanger for cooling the CO2 originating from a non-cryogenic capture unit.
The cooled CO2 may be partially condensed, the liquid phase being injected into the column for joint purification with the liquid CO2 from the cryogenic unit. The gas phase may also be injected into the column or mixed with the top gas from the column, or recycled into another step of the cryogenic process (upstream of the partial condensation) or considered to be a by-product.
The pressure after compression of the CO2 originating from a non-cryogenic capture unit may be greater than that of the distillation column. In this case, the CO2 after cooling (or its gas and liquid phase) is expanded before injection into the distillation column.
The CO2 originating from a non-cryogenic capture unit may be injected into the distillation column at a different level from the liquid CO2 originating from the cryogenic unit or at the same level.

This arrangement makes it possible to minimize the energy for separating the CO2 originating, for example, from a non-cryogenic capture unit, by avoiding diluting it with the gas to be treated by the cryogenic unit while at the same time making it possible to purify it without additional equipment (common distillation column).

It also makes it possible to increase the yield of recovery of the CO2 originating from a non-cryogenic capture unit. If it had been mixed with the gas to be treated by the cryogenic unit, CO2 losses would be observed corresponding to the yield of the partial condensation of the cryogenic unit. In the case where the CO2 is directly injected into the distillation column, only the reboiling losses apply and consideration is often given to recycling the top gas from the distillation column upstream of the cryogenic unit in order to minimize these losses.

Provided according to one subject of the invention is a process for purifying CO2, wherein:
i) a first fluid comprising at least 35% by volume but less than 90% by volume of CO2 and containing at least one first impurity that is lighter than CO2, such as methane, carbon monoxide, dihydrogen, nitrogen, oxygen or argon, is compressed; the compressed first fluid is cooled; it is partially condensed to generate a first gaseous phase depleted in CO2 and enriched in the at least one first impurity and a first liquid phase enriched in CO2 and depleted in the at least one first impurity; and the first liquid phase is expanded,
ii) a second fluid, different from the first gaseous or liquid phase or a fluid produced by separating the first gaseous or liquid phase, comprising at least 95% by volume of CO2 and containing at least one lighter second impurity such as methane, carbon monoxide, dihydrogen, nitrogen, oxygen or argon, is compressed; the compressed second fluid is cooled either by completely condensing it or by partially condensing the compressed and cooled second fluid to generate a second gaseous phase depleted in CO2 and enriched in the at least one second impurity and a second liquid phase enriched in CO2 and depleted in the at least one second impurity; and the second liquid phase is optionally expanded,
iii) the expanded first liquid phase and either the compressed, cooled and condensed second fluid or the, optionally expanded, second liquid phase are injected into a distillation column to generate a third gaseous phase depleted in CO2 and enriched in the at least one first impurity and a third liquid phase enriched in CO2 and depleted in the at least one first impurity.

According to other optional aspects of the invention:
the third gaseous phase is enriched in the at least one second impurity and a third liquid phase is depleted in the at least one second impurity.
the first fluid comprises a first main impurity that is lighter than CO2 and the content of which is greater than that of any other impurity that is lighter than CO2 in the first fluid and the second fluid comprises a second main impurity that is lighter than CO2 and the content of which is greater than that of any other impurity that is lighter than CO2 in the second fluid, the first main impurity not having the same chemical composition as the second main impurity.
the first fluid is a fluid that is different from the second gaseous or liquid phase or a fluid produced by separating the second gaseous or liquid phase.
the first and second fluids are cooled in the same heat exchanger, preferably by heat exchange with at least a portion of the third gaseous phase and/or at least a portion of the third liquid phase.
the second fluid is compressed to a pressure greater than that of the distillation column and the second fluid is expanded upstream of the column.
the first liquid phase and the second fluid or the second liquid phase are sent to different levels of the column.
the first liquid phase and the second fluid or the second liquid phase are mixed upstream of the column, optionally after having expanded the fluid and/or at least one of the liquids.
the first fluid originates, preferably exclusively, from a first source and the second fluid originates, preferably exclusively, from a second source different from the first source.
the second fluid originates, preferably exclusively, from at least one hydrocarbon reforming unit or from at least one combustion unit or from at least one unit for separation via partial condensation and/or distillation.
the first fluid originates, preferably exclusively, from at least one absorption unit, such as at least one amine or methanol scrubbing unit, or from at least one adsorption unit, such as a pressure swing adsorption unit, or from at least one combustion unit, for example an oxy-fuel combustion unit.
the first fluid originates exclusively from at least one absorption unit, such as at least one amine or methanol scrubbing unit.
the first fluid originates exclusively from at least one adsorption unit, such as a pressure swing adsorption unit, or from at least one combustion unit, for example an oxy-fuel combustion unit.
the first fluid is compressed in a first compressor and the second fluid is compressed in a second compressor, the two compressors being driven preferably by different means.
the first fluid is compressed by the first compressor to a pressure that is higher than that to which the second fluid is compressed by the second compressor.
the first liquid phase is sent to the column at a level above the level at which the condensed second fluid or the second liquid phase is sent.
the first fluid is compressed to a pressure between 8 and 12 bar abs.
the second fluid is compressed to a pressure between 8 and 25 bar abs.
the column operates at between 8 and 12 bar abs.
   the first fluid is dried in a first dryer and the second fluid is dried in a second dryer that is independent of the first dryer.
   the first fluid is cooled in a first cooler and the second fluid is cooled in a second cooler that is independent of the first cooler.
   the first fluid is cooled in a first cooler upstream of the heat exchanger and the second fluid is cooled in a second cooler that is independent of the first cooler upstream of the heat exchanger.
   the first fluid sent to the first cooler is at a different temperature from the second fluid sent to the second cooler.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

The invention will be described in more detail with reference to [FIG. 1].

FIG. 1 illustrates a process according to the invention.

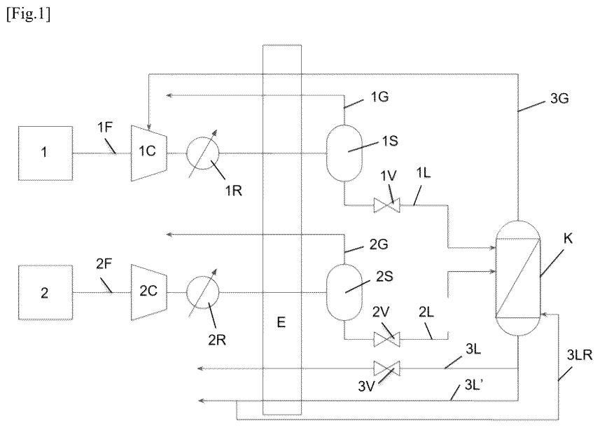

### DETAILED DESCRIPTION OF THE INVENTION

A first source 1 produces a first fluid 1F comprising at least 35% by volume but less than 90% by volume of CO2. The first source 1 may be at least one absorption unit, such as an amine or methanol scrubbing unit, and/or at least one adsorption unit, such as a pressure swing adsorption unit, and/or at least one oxy-fuel combustion unit. Preferably, the first fluid 1F originates exclusively from the first source 1.

The first fluid 1F contains at least one first impurity that is lighter than CO2, such as methane, carbon monoxide, dihydrogen, nitrogen, oxygen or argon. The main impurity that is lighter than CO2 and the content of which is greater than that of the other impurity/impurities that is/are lighter than CO2 may be methane, carbon monoxide, dihydrogen, nitrogen, oxygen or argon. The first fluid 1F is compressed in a first compressor 1C, optionally dried in a first dryer, and then the compressed first fluid is cooled first of all by a cooler 1R and then in a heat exchanger E in which the first fluid 1F is partially condensed to generate a first gaseous phase 1G depleted in CO2 and enriched in the at least one first impurity and a first liquid phase 1L enriched in CO2 and depleted in the at least one first impurity in a phase separator 1S. The first liquid phase 1L is expanded in a valve 1V and sent to the top of a distillation column K.

The first source 1 may be a hydrocarbon reforming unit or a combustion unit. Preferably, the first fluid originates exclusively from the first source 1.

A second source 2 produces a second fluid 2F comprising at least 95% by volume of CO2. The second source is preferably at least one hydrocarbon reforming unit and/or at least one combustion unit and/or at least one unit for separation via partial condensation and/or distillation.

The second fluid 2F contains at least one second impurity that is lighter than CO2, such as methane, carbon monoxide, dihydrogen, nitrogen, oxygen or argon. The main impurity that is lighter than CO2 and the content of which is greater than that of the other impurity/impurities that is/are lighter than CO2 may be methane, carbon monoxide, dihydrogen, nitrogen, oxygen or argon. The second fluid 2F is compressed in a second compressor 2C, optionally dried in a second dryer, and then the compressed second fluid is cooled first of all by a cooler 2R and then in a heat exchanger E in which the second fluid 2F is partially condensed to generate a second gaseous phase 2G depleted in CO2 and enriched in the at least one second impurity and a second liquid phase 2L enriched in CO2 and depleted in the at least one second impurity in a phase separator 2S. The first liquid phase 2L is expanded in a valve 2V and sent to a distillation column K at a level below the injection level of the liquid 1L.

Otherwise, the liquid 2L may be sent at a level above the injection level of the liquid 1L.

The step of partial condensation of the second fluid is not essential. The second fluid 2F may be sent to column K in gaseous form or liquid form, having been liquefied in the heat exchanger E.

According to a variant, the second fluid may thus be completely condensed, either at the column pressure or at a pressure greater than that of the column, in which case it is expanded upstream of the column. The condensed second fluid is therefore sent to the distillation column in order to be separated at a level below the injection level of the liquid 1L.

The second fluid can be at most partially condensed at a pressure lower than that at which the first fluid is partially condensed, since it contains more CO2.

The distillation column K generates a third gaseous phase 3G depleted in CO2 and enriched in the at least one first impurity at the column top and a third liquid phase enriched in CO2 and depleted in the at least one first impurity. The third liquid phase is divided into two streams, one of which, 3L, is vaporized in the heat exchanger E at the pressure of the column K and another of which, 3L′, is expanded in a valve 3V in the heat exchanger E at a pressure lower than that of the column K. A portion of the vaporized stream 3L′ is brought back to the temperature of the hot end of the heat exchanger E at the bottom of column K.

The gas 3G is heated in the heat exchanger E or else may be sent to the atmosphere without being heated.

It will be understood in this document that cryogenic temperatures may go up to as high as −40° C.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A process for purifying CO2 comprising the steps of:
i) compressing a first fluid comprising at least 35% by volume but less than 90% by volume of CO2 and containing at least one first impurity that is lighter than CO2, wherein the at least one first impurity is selected from the group consisting of methane, carbon monoxide, dihydrogen, nitrogen, oxygen, argon, and combinations thereof;
ii) cooling and partially condensing the first fluid to generate a first gaseous phase depleted in CO2 and enriched in the at least one first impurity and a first liquid phase enriched in CO2 and depleted in the at least one first impurity;
iii) expanding the first liquid phase;
iv) compressing a second fluid that is different from any fluid in steps i), ii), iii), the second fluid comprising at least 95% by volume of CO2 and containing at least one lighter second impurity selected from the group consisting of methane, carbon monoxide, dihydrogen, nitrogen, oxygen, argon and combinations thereof;
v) cooling and partially condensing the second fluid to generate a second gaseous phase depleted in CO2 and enriched in the at least one second impurity and a second liquid phase enriched in CO2 and depleted in the at least one second impurity;
vi) expanding the second liquid phase;
vii) injecting the expanded first liquid phase and either the compressed, cooled and condensed second fluid or the expanded, second liquid phase into a distillation column to generate a third gaseous phase depleted in CO2 and enriched in the at least one first impurity and a third liquid phase enriched in CO2 and depleted in the at least one first impurity.

2. The process according to claim 1, wherein the third gaseous phase is enriched in the at least one second impurity and a third liquid phase is depleted in the at least one second impurity.

3. The process according to claim 1, wherein the first fluid comprises a first main impurity that is lighter than CO2 and the content of which is greater than that of any other impurity that is lighter than CO2 in the first fluid and the second fluid comprises a second main impurity that is lighter than CO2 and the content of which is greater than that of any other impurity that is lighter than CO2 in the second fluid, the first main impurity not having the same chemical composition as the second main impurity.

4. The process according to claim 1, wherein the first fluid is a fluid that is different from the second gaseous or liquid phase or a fluid produced by separating the second gaseous or liquid phase.

5. The process according to claim 1, wherein the first and second fluids are cooled in the same heat exchanger, preferably by heat exchange with at least a portion of the third gaseous phase and/or at least a portion of the third liquid phase.

6. The process according to claim 1, wherein the second fluid is compressed to a pressure greater than that of the distillation column and the second fluid is expanded upstream of the column.

7. The process according to claim 1, wherein the first liquid phase and the second fluid or the second liquid phase are sent to different levels of the column.

8. The process according to claim 1, wherein the first liquid phase and the second fluid or the second liquid phase are mixed upstream of the column, optionally after having expanded the fluid and/or at least one of the liquids.

9. The process according to claim 1, wherein the second fluid originates from at least one combustion unit or from at least one unit for separation via partial condensation and/or distillation.

10. The process according to claim 1, wherein the second fluid originates from at least one hydrocarbon reforming unit.

11. The process according to claim 1, wherein the first fluid originates from at least one absorption unit, or from at least one adsorption unit, or from at least one oxy-fuel combustion unit.

12. The process according to claim 11, wherein the first fluid originates exclusively from the at least one absorption unit selected from the group consisting of an amine scrubbing unit or a methanol scrubbing unit.

13. The process according to claim 11, wherein the first fluid originates exclusively from the at least one adsorption unit or from the at least one oxy-fuel combustion unit.

14. The process according to claim 1, wherein the first fluid is dried in a first dryer and the second fluid is dried in a second dryer that is independent of the first dryer.

15. The process according to claim 1, wherein the first fluid is cooled in a first cooler and the second fluid is cooled in a second cooler that is independent of the first cooler.
